(19) United States
(12) Patent Application Publication
(10) Pub. No.: US 2002/0113387 A1
(43) Pub. Date: Aug. 22, 2002

(54) Toolbox

(76) Inventor: Kun-Chen Chen, Taichung Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/792,131

(22) Filed: Feb. 22, 2001

(51) Int. Cl. B62B 1/00

(52) U.S. Cl. 280/47.26

(57) ABSTRACT

A toolbox includes a main casing and at least one cover hinged on the main casing to close the main casing. At least one roller is mounted on a lower sidewall of the toolbox. At least one support longitudinally extending out from the cover wherein the and has a length corresponding to a diameter of the roller. A handle is mounted in and parallel to the back of the main casing. Multiple connection members and lips are formed on a corresponding one of the sidewalls of the toolbox except a hinging side of the main casing and the cover to secure the cover on the main casing. Then the toolbox can stand upright due to the rollers and the supports. Consequently, the user does not need to bend at the waist when handling and moving the toolbox thereby preventing the user from sustaining an injury.

### BACKGROUND OF THE INVENTION

1. Field of the Invention

The present invention relates to a toolbox, and more particularly to a toolbox that includes rollers mounted on the bottom and an expansion handle mounted on the back to easily move the toolbox.

2. Description of Related Art

A conventional toolbox in accordance with the prior art comprises a main casing and a cover hinged on the main casing to form a space to hold various kinds of tools. As is well known, most hand tools are made of metal, and the toolbox becomes very heavy and hard to move when the toolbox is full of hand tools. Furthermore, the worker may sustain an injury to his vertebra when lifting the toolbox from the ground to carry it to a new location.

The present invention has arisen to mitigate and/or obviate the disadvantages of the conventional toolbox.

### SUMMARY OF THE INVENTION

The objective of the present invention is to provide a toolbox that is highly portable and can be easily moved. Therefore, the toolbox in accordance with the present invention can prevent the user from sustaining an injury by making it unnecessary to lift the toolbox from the ground when moving the toolbox to a new location.

Accordingly, the toolbox of the present invention comprises a main casing and at least one cover covering the main casing to form a space to hold tools. Multiple connection members are formed on the junction between the main casing and the cover. The main casing includes a back having a handle mounted on the back and a bottom having rollers mounted on the bottom. The handle includes two expansion rods expendably inserted into the back of the main casing, and the bottom of the cover has multiple supports extending vertically from the bottom of the cover. Consequently, the toolbox can stand upright due to the rollers and the supports. Therefore, the user does not need to bend at the waist to handle and move the toolbox, which prevents the user from sustaining an injury.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a toolbox in accordance with the present invention;

FIG. 2 is a perspective view of a connection member on the toolbox in FIG. 1;

FIG. 3 is a perspective view of the connection member and supports on the bottom of the toolbox in FIG. 1;

FIG. 4 is an operational side plan view in partial section of a connection member on the toolbox in FIG. 1;

FIG. 5 is an operational side plan view in partial section of the connection member in FIG. 4;

FIG. 6 is a side plan view in partial section of the connection member in FIG. 4;

FIG. 7 is a side plan view of the toolbox in FIG. 1; and

FIG. 8 is an operational front plan view of the toolbox in FIG. 1 with the covers open.

### DETAILED DESCRIPTION OF THE INVENTION

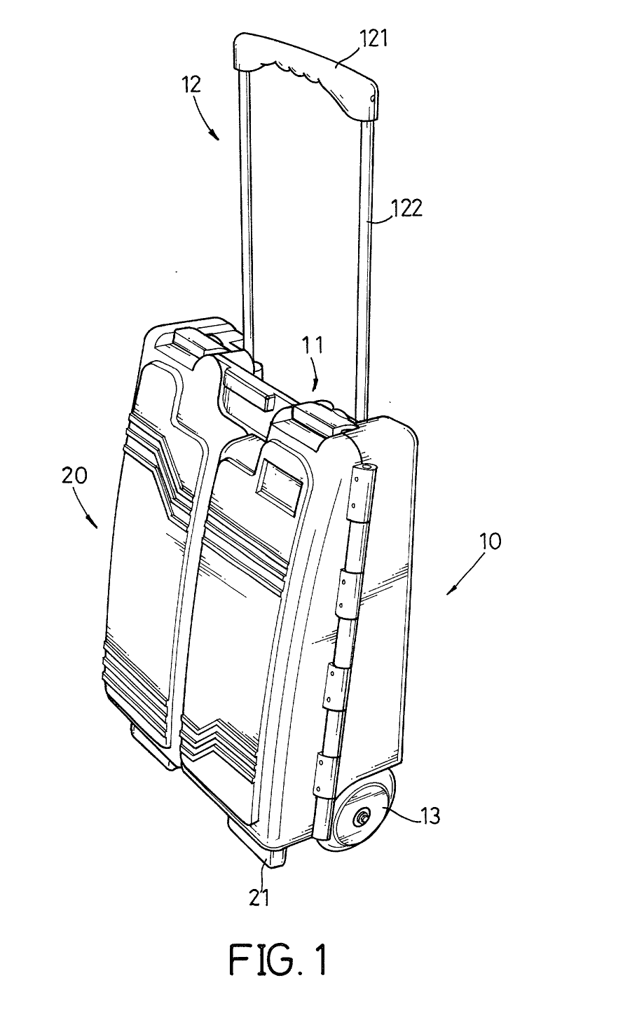

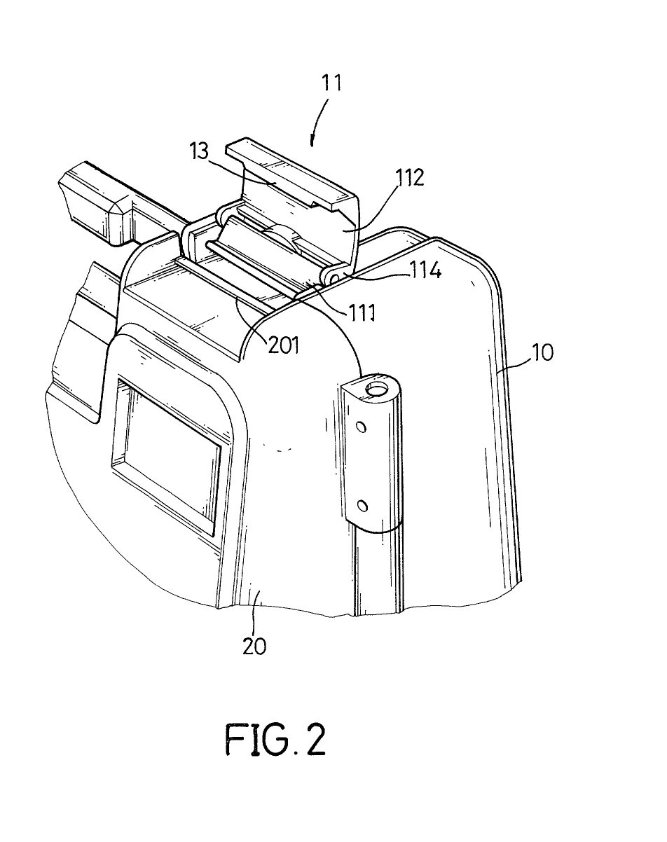

With reference to the drawings and initially to FIGS. 1 and 2, a toolbox in accordance with the present invention comprises a main casing (10) and at least one cover (20) covering the main casing (10) to form a space to hold tools in the tool box.

The main casing (10) includes a rectangular back and four sidewalls respectively extending perpendicular from the periphery of the back to form an opening and a space to hold tools. A lower sidewall of the main casing (10) has two rollers (13) respectively mounted on two opposite ends of the lower sidewall. A handle (12) is mounted in and parallel with the back of the main casing (10). The handle (12) includes a handgrip (121) and two extendable rods (122) respectively attached to opposite ends of the handgrip (121). The two extendable rods (122) are parallel to each other and are extendably inserted into the back of the main casing (10). The handle (12) is held in place by a resilient device (not shown) when the handle (12) is extended out from the main casing (10) to a suitable position. With the rollers (13), the toolbox can be moved as a handcart.

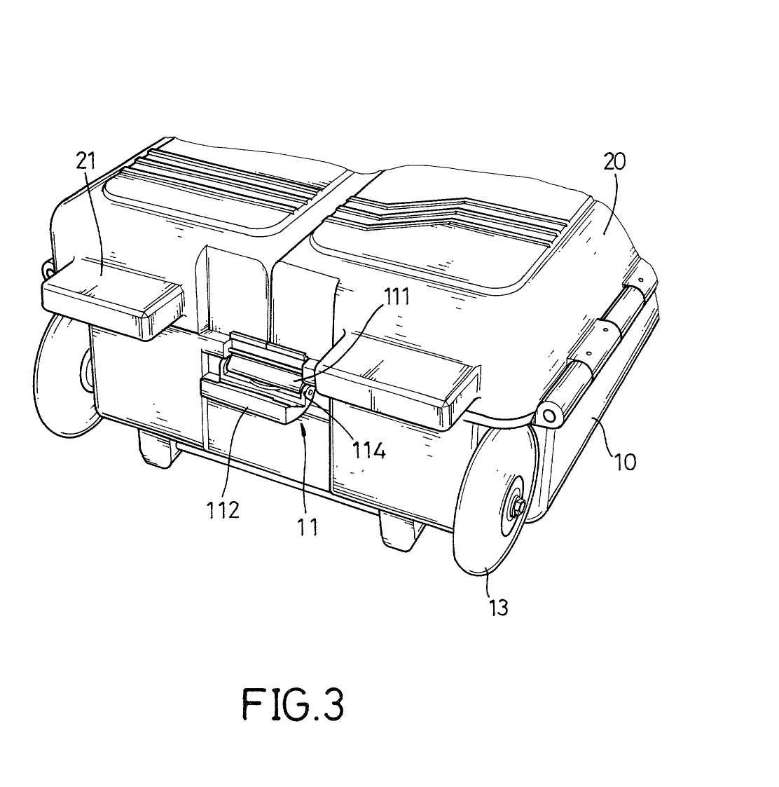

At least one cover (20) is hinged on the main casing (10) to close the opening of the main casing (10). The bottom of the cover (20)has at least one support (21) longitudinally extending out from the cover (20). The length of the support (21) corresponds to the diameter of the roller (13). The toolbox can stand upright due to the supports (21) and the rollers (13). With reference to the FIG. 3, the preferred embodiment of the toolbox includes two covers (20) respectively hinged on two opposite longitudinal sidewalls of the main casing (10) and each has a support (21) extending out from the bottom of the cover (20).

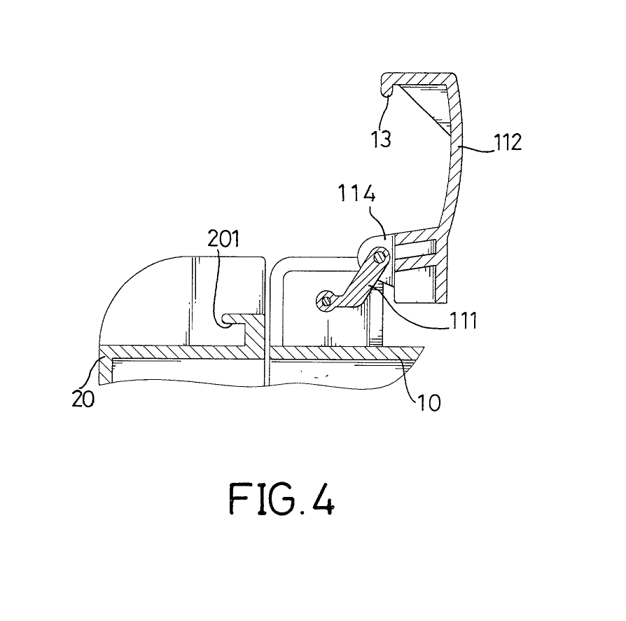

With reference to FIGS. 2 and 4, multiple connection members (11) are formed at the joint between the main casing (10) and cover (20) to secure the cover (20) on the main casing (10). In the preferred embodiment, the connection member (11) includes a hinge plate (111) pivotally attached to the main casing (10) and a clasp (112) pivotally attached to the hinge plate (111) of the connection member (11). The cross section of the hinge plate (111) is substantially L-shaped. The clasp (112) has a first side and a second side perpendicular to each other. The first side of the clasp (112) has a pair of ears (114) respectively extending from two opposite ends of the first side and each pivotally attached to a corresponding end of the hinge plate (111). The second side of the clasp (112) includes a latch (113) laterally extending inward from the second side of the clasp (112). The cover (20) has a lip (201) is formed to correspond to the latch (113) of the clasp (112). The latch (113) is engaged to the lip (201) of the cover (20).

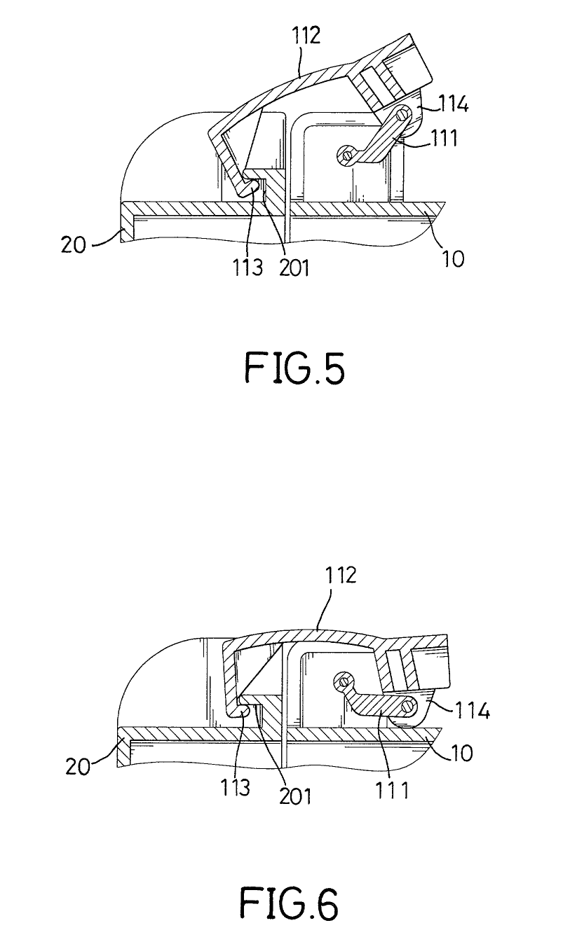

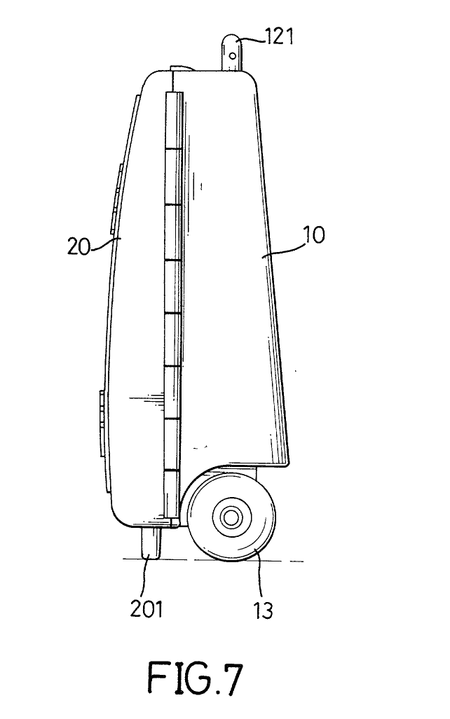

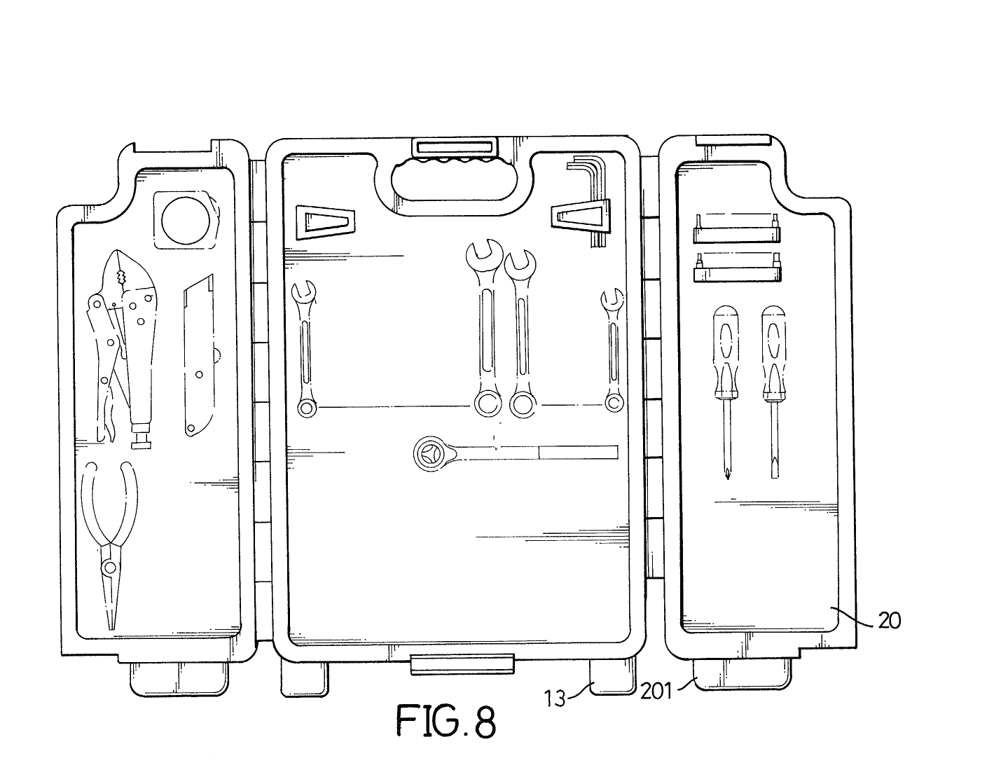

With reference to the FIGS. 5 and 6, to secure the cover (20) to the main casing (10), the latch (113) is put into the lip (201) on the cover (20) and the clasp (112) is pressed toward the main casing (10). The substantially L-shaped hinge plate (111) will perform a cam-like function. Consequently, the clasp (112) is pulled toward the main casing (10) and the latch (113) is securely engaged in the lip (201) when the ear (114) of the clasp (112) abuts the main casing (10).

With reference to FIG. 8, the covers (20% can be fully opened so that user can easily take the tools from the toolbox. Furthermore, the cover (20) is designed to have a space holding tools that increases the capacity of the toolbox.

The design with the handle (12) and the rollers (13) allows the toolbox to be moved easily to prevent the user from sustaining an injury when moving the toolbox. Furthermore, the user can take a suitable tool from the toolbox conveniently because the cover (20) of the present invention can be opened fully.

Although the invention has been explained in relation to its preferred embodiment, it is to be understood that many other possible modifications and variations can be made without departing from the spirit and scope of the invention as hereinafter claimed.

What is claimed is:

1. A toolbox comprising:
a main casing including a back and multiple sidewalls respectively extending from a periphery of the back to form an opening to hold tools; at least one roller mounted on one of the sidewalls;
a handle mounted in and parallel to the back of the main casing, the handle including a handgrip and two extendable rods respectively attached to opposite ends of the handgrip, the two extendable rods parallel to each other and extendably inserted into the back of the main casing;
at least one cover hinged on the main casing to close the opening of the main casing and having at least one support longitudinally extending out from the cover, the support having a length corresponding to a diameter of the roller;
multiple lips formed on the cover; and
multiple connection members formed on the side walls of the main casing to engage to the lip for securing the cover on the main casing.

2. The toolbox as claimed in claim 1, wherein the connection member comprises a hinge plate pivotally attached to the toolbox and a clasp pivotally attached to the hinge plate, the clasp including a first side and a second side, the first side of the clasp having a pair of ears respectively extending from two opposite ends, and each pivotally attached to a corresponding end of the hinge plate, the second side of the clasp having a latch laterally extending inward and secured under the lip.

3. A toolbox comprising:
a main casing including a back and multiple sidewalls respectively extending from a periphery of the back to form an opening to hold tools; at least one roller mounted on one of the sidewalls;
a handle mounted in and parallel to the back of the main casing, the handle including a handgrip and two extendable rods respectively attached to opposite ends of the handgrip, the two extendable rods parallel to each other and extendably inserted into the back of the main casing;
at least one cover hinged on the main casing to close the opening of the main casing and having at least one support longitudinally extending out from the cover, the support having a length corresponding to a diameter of the roller;
multiple lips formed on the side walls of the main casing; and multiple connection members formed on the cover to engage to the lip for securing the cover on the main casing.

4. The toolbox as claimed in claim 3, wherein the connection member comprises a hinge plate pivotally attached to the toolbox and a clasp pivotally attached to the hinge plate, the clasp including a first side and a second side, the first side of the clasp having a pair of ears respectively extending from two opposite ends, and each pivotally attached to a corresponding end of the hinge plate, the second side of the clasp having a latch laterally extending inward and secured under the lip.
